(19) United States
(12) Patent Application Publication
(10) Pub. No.: US 2015/0281212 A1
(43) Pub. Date: Oct. 1, 2015

(54) METHOD FOR PROVIDING CONFIDENTIAL DATA-BASED LOGIN SERVICE

(71) Applicant: BASEIN NETWORKS INC., Seongnam-si Gyeonggi-do (KR)

(72) Inventors: Dong Hoon Shin, Suwon-si Gyeonggi-do (KR); Hee Jun Kim, Suwon-si Gyeonggi-do (KR)

(21) Appl. No.: 14/437,849

(22) PCT Filed: Nov. 28, 2013
(86) PCT No.: PCT/KR2013/010902

§ 371 Date: Apr. 23, 2015

(30) Foreign Application Priority Data
Jul. 25, 2013 (KR) 10-2013-0087773

(51) Int. Cl. H04L 29/06; G06F 21/36

(52) U.S. Cl. CPC H04L 63/083; G06F 21/36

(57) ABSTRACT

Provided is a method for providing a confidential data-based login service, comprising the steps of: receiving, from a user equipment, identification (ID) data on the basis of a login event; transmitting, to the user equipment, at least one confidential data that has been previously matched to an ID of the user equipment and stored, along with decoy data and false data; receiving, from the user equipment, at least one unique ID data corresponding to an event of selecting at least one confidential data; and providing a login service to the user equipment if the received at least one unique ID data matches at least one unique ID data that has been previously matched to the ID of the user equipment and stored.

### TECHNICAL FIELD

The present invention relates to a method for providing a confidential data-based login service.

### BACKGROUND ART

In recent, as many incidents of leakage of personal information occur, it is a trend that an issue becomes a conversation topic that reprimand against a security company capable of preventing the leakage of personal information and security have to be strengthened. In a case where the ID and password transmitted between a client and the server are hijacked, the ID and password of the user can be easily exposed since the ID and password consist of characters.

At this time, a method of setting a password with images includes a method of connecting images randomly created in a pattern. In this connection, Korean Laid-Open Patent Application No. 2010-0065135 (published on Jun. 15, 2010) discloses a method for determining whether to cancel security by means of the order of images, wherein the order determined by a user is assigned to correspond to a password and images corresponding to the password are selected from randomly arranged images by the user.

However, a method of changing a pattern in view of easy leakage of the pattern of a mobile terminal cannot be applied to communication between a client and a server. Furthermore, also in a case where login is made by a public certificate in a mobile-based terminal, randomly arranged keys on a keyboard are used for keyboard security, and therefore, in most case, the user gives up the login in the mobile terminal and again proceeds with the login in a PC when alphabetical characters corresponding to Korean characters are set as a password.

### SUMMARY OF THE INVENTION

### Technical Problem

One embodiment of the present invention can provide a method for providing a confidential data-based login service which allows input of the password by simple touch or click by using the password such as image, video or voice while deviating from a way of login by a character-based password and also allows the login without downloading and installing the security program such as Active X and allows only random character string mapped to the confidential data to be received and transmitted between the client and the server and thus can reduce the risk of leakage of information by hijacking.

However, the technical problem to be solved by the present embodiment is not limited to the above-mentioned technical problem, and another technical problems may be present.

### Solution to the Problem

As a technical solution to the above-mentioned technical problem, one embodiment of the present invention includes a step of receiving ID data from a user terminal based on a login event; a step of transmitting, to the user terminal, at least one confidential data which has been previously matched to the ID of the user terminal and stored, along with decoy data and false data; a step of receiving, from the user terminal, at least one unique identification data corresponding to an event of selecting the at least one confidential data; and a step of providing the login service for the user terminal in a case where the at least one received unique identification data and the at least one unique identification data previously matched and stored coincide with each other.

### Effects of the Invention

According to the above-described solution to the problem of the present invention, an original confidential data selected by the user is stored in a separate server and only unique identification data which has been set randomly to be mapped to the confidential data is stored while being mapped to the user ID, whereby the confidential data set by the user cannot be identified even if the sever is hacked, and the unique identification data mapped to the confidential data is differently set for the same confidential data, and thus the original confidential data cannot be indentified from the outside.

### BRIEF DESCRIPTION OF THE DRAWINGS

FIG. 1 is a constructional view for describing a system for providing a confidential data-based login service according to one embodiment of the present invention;

FIG. 2 is a constructional view for describing the server for providing a confidential data-based login service illustrated in FIG. 1;

FIGS. 3 to 8 are view illustrating an example where the method for providing a confidential data-based login service according to the one embodiment of the present invention is implemented in the server for providing a confidential data-based login service and the user terminal illustrated in FIG. 1;

FIG. 9 shows a process of the data being transmitted and received between respective components included in the system for providing a confidential data-based login service of FIG. 1 according to the one embodiment of the present invention; and

FIG. 10 is an operational flow chart for describing the method for providing a confidential data-based login service according to the one embodiment of the present invention.

### BEST MODES FOR CARRYING OUT THE INVENTION

In the following, an embodiment of the present invention will be described in detail with reference to the attached drawings so that those skilled in the art can carry out the present invention. However, the present invention may be embodied in various different forms and is not limited to the embodiment described herein. Furthermore, parts not related to the description of the present invention are omitted from the drawings for the purpose of clearly describing the present invention, and like reference numerals are assigned to like parts throughout the specification.

Throughout the specification, when it is described that an element is “connected” to another element, the element may be “directly connected” to the other element or “electrically connected” to the other element through a third element. In addition, unless explicitly described to the contrary, the word “comprise” will be understood to imply the inclusion of stated elements but not the exclusion of any other elements and should be understood not to previously exclude a possibility of presence or addition of one or more other features, numbers, steps, actions, elements, parts or combination thereof.

Hereinafter, the present invention will be described in detail with reference to the attached drawings.

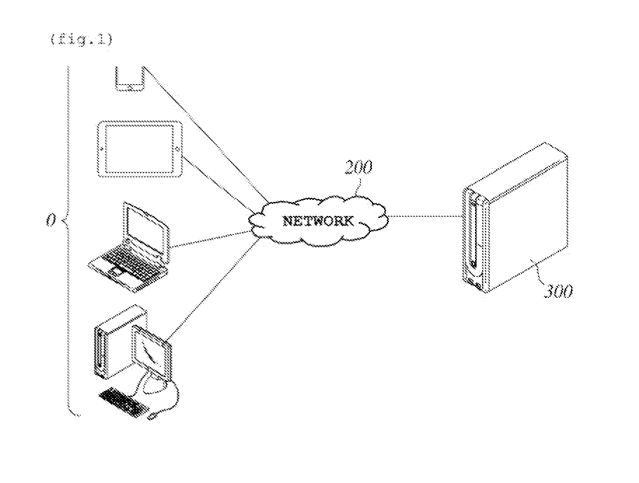

FIG. 1 is a constructional view for describing a system for providing a confidential data-based login service according to one embodiment of the present invention. Referring to FIG. 1, the system (1) for providing a confidential data-based login service may include a user terminal (100) and a server (300) for providing confidential data-based login service. However, such a system (1) for providing confidential data-based login service of FIG. 1 is merely one embodiment of the present invention, and thus the present invention should not be construed to be limited by FIG. 1.

Respective elements in FIG. 1 are generally connected through a network (200). For example, as illustrated in FIG. 1, the user terminal (100) and the server (300) for providing a confidential data-based login service may be connected through the network (200). Here, the network (200) refers to a connecting structure which allows information exchange between respective nodes such as terminals and servers. An example of such a network (200) includes Internet, LAN (Local Area Network), Wireless LAN (Wireless Local Area Network), WAN (Wide Area Network), PAN (Personal Area Network), 3G, 4G, LTE, Wi-Fi or the like, but is not limited to them. The user terminal (100) and the server (300) for providing a confidential data-based login service illustrated in FIG. 1 should not be construed to be limited to those illustrated in FIG. 1.

The user terminal (100) may be at least one terminal connected to the server (300) for providing a confidential data-based login service.

Further, the user terminal (100) may be a terminal in which a mouse or touch, not a keyboard or keys, is used at the time of membership registration and login certification. Accordingly, the user terminal (100) may be a terminal in which a program related to security such as Active X may not be installed at the time of membership registration and login certification. Further, the user terminal (100) may be a terminal in which character data (string) is used as ID data at the time of membership registration and login certification and in which image, voice, video or character stored in the user terminal (100) is used as confidential data (password). In this connection, the confidential data may be the image, voice, video or character received from the server (300) for providing a confidential data-based login service. Also, the user terminal (100) may transmit unique identification data mapped to the confidential data, not the confidential data itself, when selecting the confidential data and transmitting the same to the server (300) for providing a confidential data-based login service at the time of login certification. Thereby, even when hijacking occurs between the user terminal (100) and the server (300) for providing a confidential data-based login service, strong security can be kept since is impossible to know what the confidential data selected in the user terminal (100) is.

The user terminal (100) may be embodied as a computer which can be connected to a remote server or terminal through the network (200). Here, the computer may include, for example, a notebook, desktop, laptop or the like with WEB Browser installed therein. The user terminal (100) may be embodied as a terminal connectable to a remote server or terminal through the network (200). The user terminal (100) is, for example, a wireless communication device ensuring portability and mobility and may include all kinds of handheld wireless communication devices such as PCS (Personal Communication System), GSM (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), Wibro (Wireless Broadband Internet) terminal, smartphone, smartpad, Tablet PC or the like.

When the membership registration event has occurred in the user terminal (100), the server (300) for providing a confidential data-based login service can receive the ID data from the user terminal (100) and transmit at least one confidential data mapped to the ID data to the user terminal (100). Here, the server (300) for providing a confidential data-based login service may also transmit similar data analogous to the at least one confidential data and false data in addition to the at least one confidential data. At this time, the user terminal (100) may select, from the at least one confidential data, one, or a plurality of, confidential data which the user of the user terminal (100) wants. The one, or plurality of, confidential data selected from the user terminal (100) can be transmitted to the server (300) for providing a confidential data-based login service. Here, the server (300) for providing confidential data-based login service can randomly create the unique identification data for the one or plurality of confidential data, and the created unique identification data can be mapped to the one or plurality of confidential data and ID data of the user terminal (100) and be stored in a table.

The server (300) for providing a confidential data-based login service can store the ID data of the user terminal (100) and the unique identification data in a database in the server itself, and the one or plurality of confidential data can be stored in a database in a separate server or be stored in a database separate from the database stored in the form of table. Thereby, even when the database of the server (300) for providing a confidential data-based login service is hacked, a risk can be eliminated that the confidential data selected by the user terminal (100) is leaked. The server (300) for providing a confidential data-based login service may be embodied as a computer which can be connected to a remote server of terminal through the network (200). Here, the computer may include the notebook, desktop, laptop or the like with WEB Browser installed therein.

In the following, a method for providing a confidential data-based login service according to the one embodiment of the present invention described above will be described by way of example.

In recent, as many incidents of leakage of personal information occur, it is a trend that an issue becomes a conversation topic that reprimand against a security company capable of preventing the leakage of personal information and security have to be strengthened. In a case where the ID and password transmitted between a client and the server are hijacked, the ID and password of the user can be easily exposed since the ID and password consist of characters.

Further, for setting the ID and password, IE (Internet Explorer)-based Active X program has to be necessarily installed, and Chrome or Firefox not based on the IE does not support a security program and thus does not allow login itself. Further, also in a case where the login is made by a public certificate in a mobile-based terminal, randomly arranged keys on the keyboard have to be used for keyboard security. Therefore, in a case where alphabetical characters corresponding to Korean characters are set as a password, in most case, the user usually gives up login in the mobile terminal and proceeds with the login again in PC. Further, a plurality of programs for security of the keys on the keyboard are installed in the mobile terminal. Therefore, there are increasing cases that the user using the 3G totally gives up the login during downloading of a program or although the security program has been downloaded and installed, its speed is too slow and thus the login is also gave up.

Therefore, the method for providing a confidential data-based login service according to the one embodiment of the present invention allows input of the password by simple touch or click by using the password such as image, video or voice while deviating from a way of login by a character-based password. Further, the method for providing a confidential data-based login service according to the one embodiment of the present invention allows the login without downloading and installing the security program such as Active X and allows only random character string mapped to the confidential data to be received and transmitted between the client and the server, and thus can reduce the risk of leakage of information by hijacking. Further, the method for providing a confidential data-based login service according to the one embodiment of the present invention stores an original confidential data selected by the user in a separate server and stores only unique identification data which has been set randomly to be mapped to the confidential data, while mapping the unique identification data to the user ID, whereby the confidential data set by the user cannot be identified even if the sever is hacked. At this time, the unique identification data mapped to the confidential data is differently set for the same confidential data, and thus the original confidential data cannot be indentified from the outside.

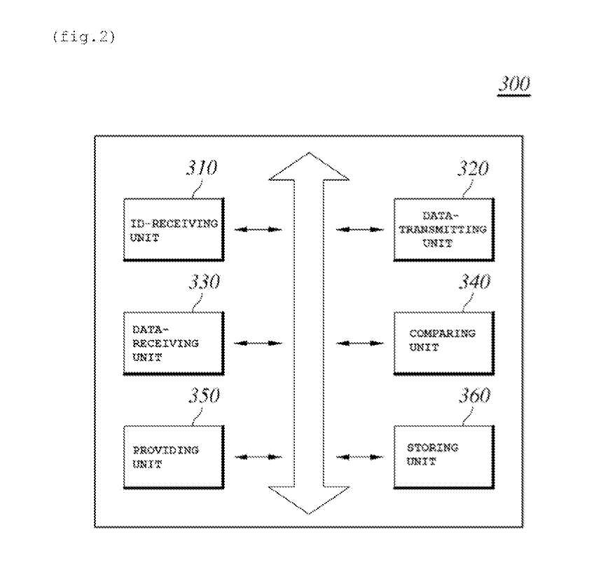

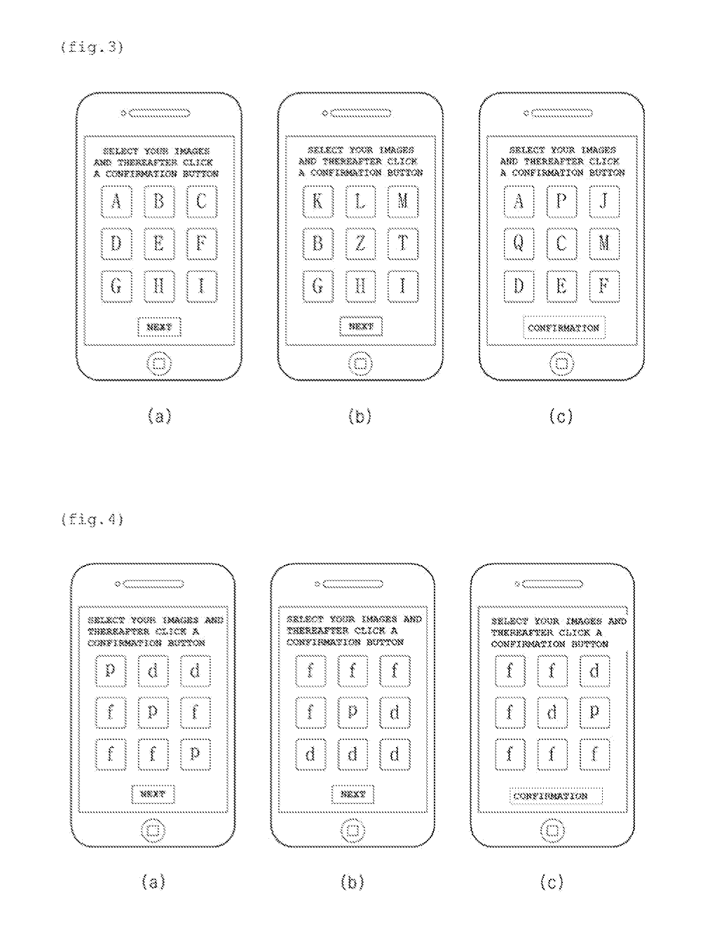

FIG. 2 is a constructional view for describing the server for providing a confidential data-based login service illustrated in FIG. 1, and FIGS. 3 to 8 are view illustrating an example where the method for providing a confidential data-based login service according to the one embodiment of the present invention is implemented in the server for providing a confidential data-based login service and the user terminal illustrated in FIG. 1.

Referring to FIG. 2, the server (300) for providing confidential data-based login service according to the one embodiment of the present invention may include an ID-receiving unit (310), a data-transmitting unit (320), a data-receiving unit (330), a comparing unit (340), a providing unit (350) and a storing unit (360).

When the server (300) for providing a confidential data-based login service according to the one embodiment of the present invention or another server (not illustrated) operating in association with the server (300) for providing a confidential data-based login service transmits an application, program, web page or the like for confidential data-based login to the user terminal (100), the user terminal (100) can install or open the application, program, web page or the like for a relevant service. Further, the program for confidential data-based login may be driven in the user terminal (100) by the use of a script executed in the web browser. Herein, the web browser refers to a program which allows WWW (world wide web) service to be used and receives and shows a hyper text described by HTML (hyper text mark-up language). The Web browser includes Netscape, Explorer, Chrome or the like for example. Further, the application refers to an applied program (application) in the terminal and includes, for example, an app executed in a mobile terminal (smartphone).

At this time, the connection of the network (200) means that the user terminal (100) and the server (300) for providing a confidential data-based login service are communicatingly connected to each other, and creation of the connection of the network (200) means that the server (300) for providing a confidential, data-based login service creates a communication object at communication contact point for communication with the terminal connected to the server by the network (200). The server (300) for providing a confidential data-based login service can exchange data with the terminal through the communication object.

The ID-receiving unit (310) can receive the ID data from the user terminal (100) based on the login event. At this time, the ID data may be character data. The user terminal (100) may proceed with the membership registration before performing the login event, and the ID-receiving unit (310) may receive the ID data from the user terminal (100) based on an event of request for membership registration.

The data-transmitting unit (320) transmits, to the user terminal (100), at least one confidential data which has been previously matched to ID of the user terminal (100) and stored, along with decoy data and false data. The user terminal (100) may proceed with the membership registration before performing the login event, and the data-transmitting unit (320) may transmit the at least one confidential data corresponding to the ID data so that the confidential data is displayed on a screen of the user terminal. Accordingly, the user of the user terminal (100) can set at least one confidential data which the user wants.

In this connection, referring to FIG. 3, a process will be described of setting the at least one confidential data which the user wants in the user terminal (100) and logging in by the use of the confidential data. With reference to FIG. 3(a), a screen saying “selecting your image and thereafter pressing a confirmation button” can be provided on the user terminal (100). At this time, the total number of the images provided may be variously varied depending on an environment of the client, i.e. the user terminal (100) and the level of site security thereof. For example, when the user terminal (100) is a PC, the total number may be 8 to 16, and when the user terminal is a mobile terminal, the total number may be 6 to 8.

At this time, with reference to FIG. 3(b), in a case where images “A” and “C” have been registered in the user terminal (100), the user may click a “NEXT” button since the user terminal (100) does not have, on its first screen, the images registered by the user. The user selects “A” and “C” on a next screen and thereafter clicks a “CONFIRMATION” button, whereby login can be normally made. At this time, in a case where “A” and “C” are not selected in the user terminal (100), error message regarding the password may be received.

Referring again to FIG. 2, the data-receiving unit (330) receives, from the user terminal (100), at least one unique identification data corresponding to an event of selecting the at least one confidential data. At this time, the user terminal (100) may proceed with the membership registration before performing the login event, and if at least one of the at least one confidential data is selected in the user terminal (100), the data-receiving unit (330) may receive, from the user terminal (100), the at least one unique identification data which has been previously matched to the at least one selected confidential data. The storing unit (360) can match the least one received unique identification data to the ID data and store the same in a labeled table. Here, in the storing unit (360), the ID data of the user terminal (100) and the at least one unique identification data are matched to each other and stored in the labeled table in the database, and the at least one confidential data to which the at least one unique identification data has been assigned may be stored in a database separate from the database in which the table is stored. Accordingly, it is totally impossible to know from the outside which confidential data has been set as user's password in the user terminal (100) or which confidential data has been entered as a password. Further, when the membership registration event occurs in the user terminal (100), the at least one unique identification data is randomly created to correspond to the at least one confidential data, and the at least one confidential data and the at least one unique identification data can be matched to each other in an one-to-multi relationship.

At this time, the storing unit (360) does not store the confidential data (image, voice, video, and characters) in a binary form in the database itself, but may store only unique identification data for the confidential data. For example, it may be stored in the form of the following Table 1.

TABLE 1

| ID | ID_IMG |
|---|---|
| hong | 12333xyddaaaa |
| hong | 1029333ddzzyd |
| kim | 20339aadd |
| kim | azzeddfa222 |
| kim | 3930szzd00az |
| kim | gjtlda938z |
| kim | 33i9d11234zzg |

Further, the unique identification data for the confidential data may have a certain format designated according to sites, may contain data format information according to the unique identification data, may have a data name which is randomly created when the user registers the data, and may include a specific format for each site. For example, if it is assumed that an image “a.jpg” has been uploaded in the user terminal (100), a new image name may be “2309aazt”, and “32309aazt” may be created as a name having an image format, and “ab312309aazt” may be created as a name with other rules (fake, real) applied thereto.

The comparing unit (340) compares the at least one received unique identification data with the at least one unique identification data previously matched and stored, and in a case where the at least one received unique identification data and the at least one unique identification data previously matched and stored coincide with each other, the providing unit (350) provides the login service for the user terminal (100). At this time, in a case where the ID data received from the user terminal (100) is not an ID data previously stored and registered, the providing unit (350) may transmit a plurality of the false data to the user terminal (100). Thereby, it is impossible to check whether the ID data has been wrongly entered in the user terminal (100) or whether the confidential data has been wrongly entered, and thus the ID data and the confidential data can be prevented from being inferred.

The confidential data may be at least one of Passimage, Passvoice, Passvideo and Passmessage. For example, the password means a key set by the user including characters, numbers and symbols, and the confidential data may be defined by a key set by the user including the image, voice, video and characters capable of covering the password. Therefore, since the user terminal (100) allows inputting of the confidential data without using the keys of the keyboard, login can be made without installing the security program such as Active X, and the login can be made even without driving a security program related to the keys of the keyboard.

Further, in the case of the at least one confidential data, decoy data and false data transmitted to the user terminal (100), the confidential data, decoy data and false data may be arranged in array on the screen of the user terminal (100) while mixed with one another. At this time, in a case where a plurality of the confidential data are present, the number of the screens displayed on the user terminal (100) may be determined based on the number of the plurality of confidential data. That is, the at least one confidential data, decoy data and false data transmitted to the user terminal (100) may be displayed such that one data is displayed by stages on the screen of the user terminal (100).

In this connection, description will be made with reference to FIG. 4. In a case where the confidential data set in the client, i.e. the user terminal (100) is the passimage and the server (300) for providing a confidential data-based login service has received a request for the passimage conforming to the ID data, the passimage of the user is transmitted as a necessary condition to the user terminal (100) and the decoy image and false image may be transmitted as a sufficient condition to the user terminal.

At this time, if it is assumed that the number of the images to be transmitted is “t”, the number of the passimages associated with the ID data, i.e. the number (p) of the passimages set in the user terminal (100) may be defined by the following equation 1:

p=t−i (1≦i≦t−r) [Equation 1]

where, p is the number of the passimages, t is the total number of images to be transmitted to the user terminal (100), and r is a value adjustable depending the sites or characteristics of the terminal. For example, if the number of the passimages set in the user terminal (100) is two (p 2) and the total number of images to be transmitted to the user terminal is nine (t=9), the sum of the numbers of the decoy images and false images may be seven.

Further, a probability of the decoy data being exposed in the user terminal (100) may be determined based on a probability of the confidential data being exposed and may be determined by the following equation 2:

d=t−p [Equation 2]

where, d is the number of the decoy images. The equation 2 is an equation under assumption that the screen has only passimages and decoy images. In other words, this is because it is assumed that the decoy images are provided only in a number equal to a value resulting from subtraction of the number of confidential images from the total number of images. Further, the decoy image may be exposed with a probability similar to that of the passimage, whereby inference of the passimage can be minimized.

The false image may be determined by the following equation 3:

f=t−p−d [Equation 3]

where, f is the number of the false images. At this time, the equation 3 is an equation under assumption that the passimage, the decoy image and the false image are all shown on the screen.

Referring to FIG. 4(a), in a case where the total number of images to be transmitted is nine (t=9) and the number of the passimages set in the user terminal (100) is three (p=3), the number of the false images may be four (f=4) if two decoy images are inserted (d=2). Further, referring to FIG. 4(b), in a case where the total number of images to be transmitted is nine (t=9) and the number of the passimages set in the user terminal (100) is one (p=1), the number of the false images may be four (f=4) if four decoy images are inserted (d=4). Then, referring to FIG. 4(c), in a case where the total number of images to be transmitted is nine (t=9) and the number of the passimages set in the user terminal (100) is one (p=1), the number of the false images may be six (f=6) if two decoy images are inserted (d=2).

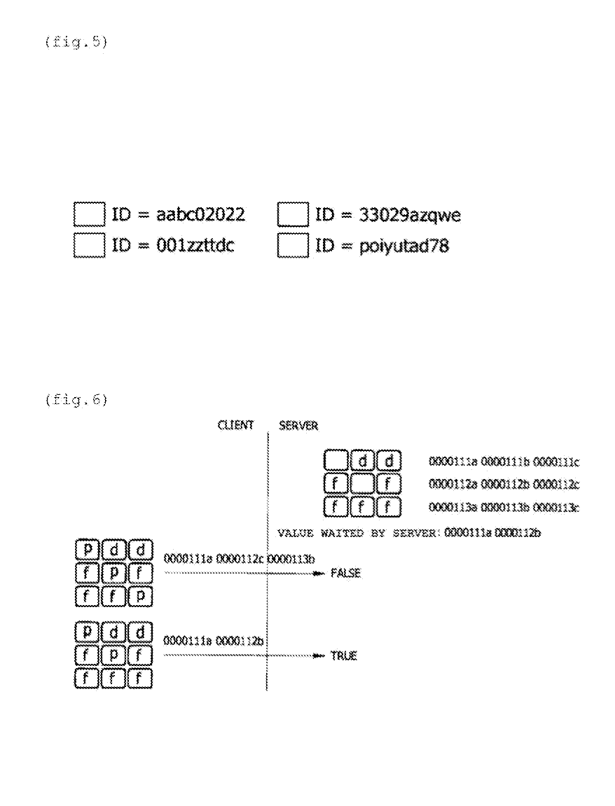

Referring to FIG. 5, an example of designating the unique identification data will be described. In this connection, referring to FIG. 5, different unique identification data may be created for the same image as follows: ID=aabc02022, ID=33029azqwe or the like. That is, when the confidential data is transmitted from the server (300) for providing confidential data-based login service to the user terminal (100), a different value of the unique identification data may be created whenever an unique identifier data is requested. Accordingly, even though the same image is transmitted, the unique identification data is created randomly, and thus the security can be enhanced. In this connection, the unique identification data has at least eight digits and may consist of mixed numbers and alphabet, and for the unique identification data, a capital letter and a small letter corresponding thereto are distinguished.

Referring to FIG. 6, by way of example, an process will be described of checking data transmission between the user terminal (100) and the server (300) for providing a confidential data-based login service and effectiveness. In this connection, it is assumed that the server (300) for providing a confidential data-based login service positions the confidential data set in the user terminal (100) at (1,1) and (2,2) and waits to receive unique identification data “0000111a” and “0000112b” mapped thereto from the user terminal (100). At this time, if “0000111a” and “0000112b” are received from the user terminal (100), the login service is provided, but otherwise, the login service is not provided.

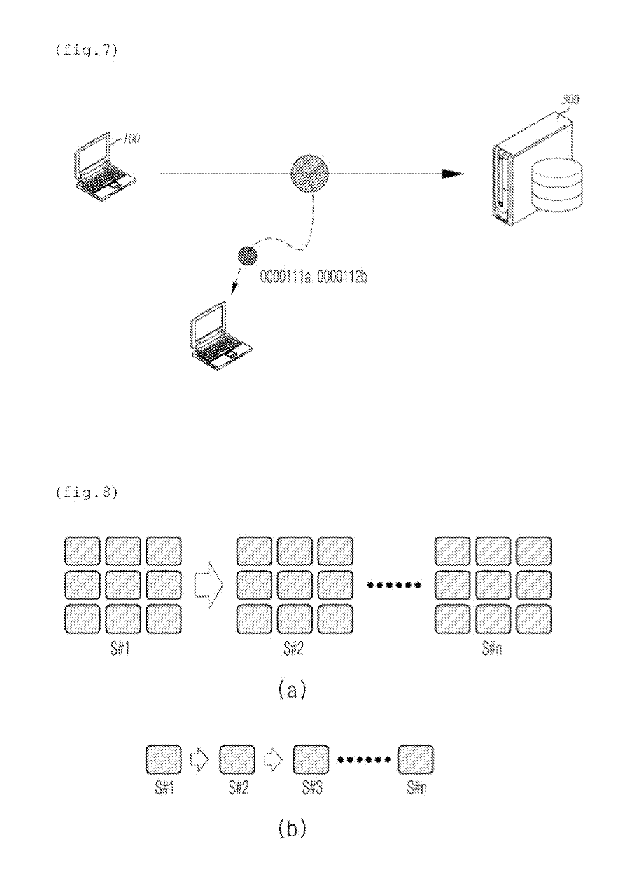

Referring to FIG. 7, by way of example, description will be made of data transmission between the user terminal (100) and the server (300) for providing confidential data-based login service. Since the user terminal (100) transmits only the unique identification data for the selected confidential data, not the selected confidential data itself, to the server (300) for providing confidential data-based login service, it is impossible to know which confidential data has been selected in the user terminal (100) even if the information is exposed by hijacking. Further, even if the ID data of the user terminal (100) and the unique identification data are obtained, thereafter, the login service cannot be provided since the unique identification data corresponding to the selected confidential data is randomly designated differently even for the same confidential data. At this time, the unique identification data may be newly issued whenever the request for login is made in the user terminal (100) or whenever the login fails.

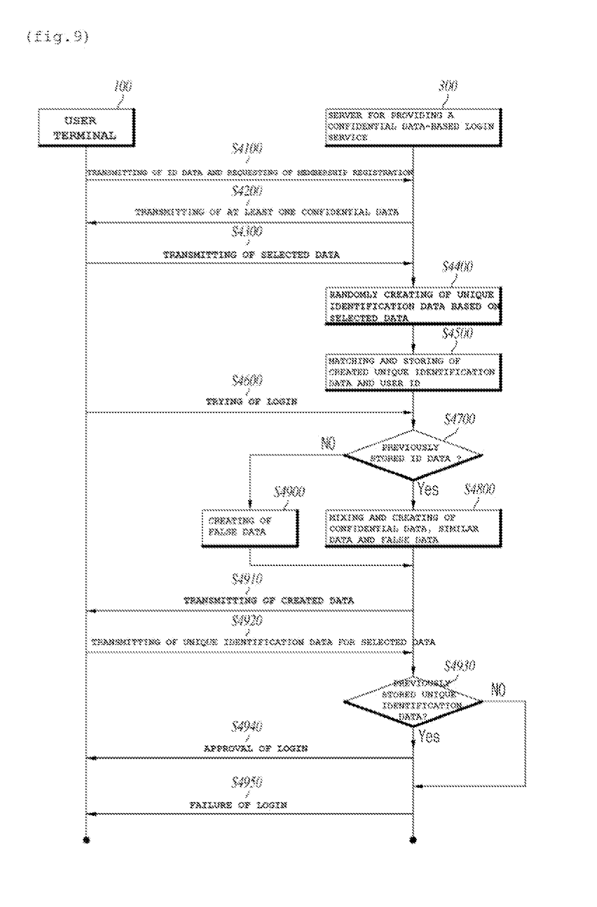

Referring to FIG. 8, a method of selecting the confidential data in the user terminal (100) will be described by way of example. At this time, a plurality of the images may be exposed by stages as shown in FIG. 8 (a) or a single image may be exposed by stages as shown in FIG. 8 (b). In the case of FIG. 8(b), only one image is exposed on one screen of the user terminal (100) and next steps are continued. Thereby, a possibility of hacking by pattern analysis due to screen capture or the like can be lowered.

The method for providing a confidential data-based login service according to the one embodiment of the present invention allows input of the password by simple touch or click by using the password such as image, video or voice while deviating from a way of login by a character-based password. Further, the method for providing a confidential data-based login service according to the one embodiment of the present invention allows the login without downloading and installing the security program such as Active X and allows only random character string mapped to the confidential data to be received and transmitted between the client and the server, and thus can reduce the risk of leakage of information by hijacking. Further, the method for providing a confidential data-based login service according to the one embodiment of the present invention stores an original confidential data selected by the user in a separate server and stores only unique identification data which has been set randomly to be mapped to the confidential data, while mapping the unique identification data to the user ID, whereby the confidential data set by the user cannot be identified even if the sever is hacked. At this time, the unique identification data mapped to the confidential data is differently set for the same confidential data, and thus the original confidential data cannot be indentified from the outside.

Particulars not described regarding the method for providing a confidential data-based login service of FIGS. 2 and 8 are identical to those described above regarding the method for providing a confidential data-based login service with reference to FIG. 1 or can be easily inferred therefrom, and therefore, related descriptions will be omitted in the following.

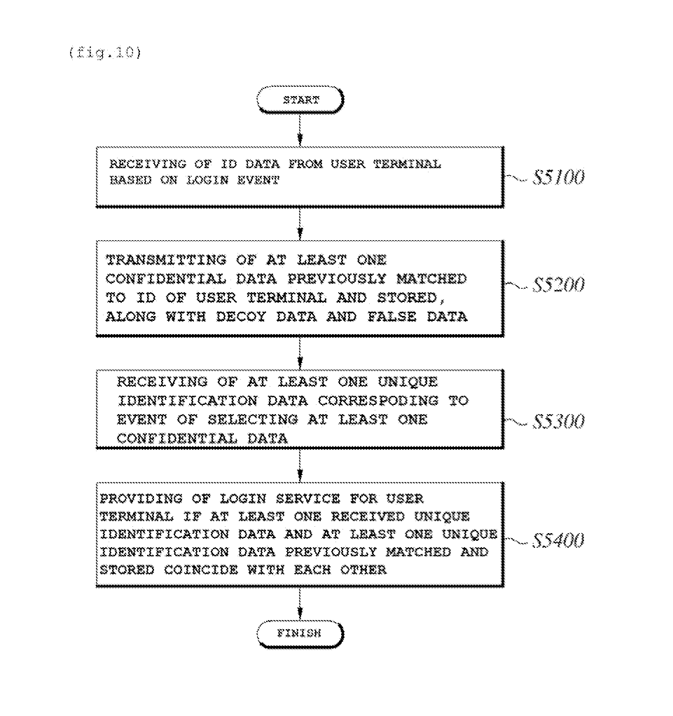

FIG. 9 shows a process of the data being transmitted and received between respective components included in the system for providing a confidential data-based login service of FIG. 1 according to the one embodiment of the present invention. Hereinafter, referring to FIG. 9, an example of process of signal being transmitted and received according to the one embodiment of the present invention, but the present invention should not be construed to be limited to such a example, and it is obvious to those skilled in the art that the process of the data being transmitted and received illustrated in FIG. 9 may be changed according to various embodiments previously described.

Referring to FIG. 9, the user terminal (100) transmits the ID data to the server (300) for providing a confidential data-based login service and makes a request for the membership registration (S4100). At this time, the server (300) for providing a confidential data-based login service transmits at least one confidential data to the user terminal (100) and makes the user select a desired confidential data (S4200).

Next, if the desired confidential data is selected from the at least one confidential data in the user terminal (100) and transmitted to the server (300) for providing a confidential data-based login service (S4300), the server (300) for providing a confidential data-based login service randomly creates the unique identification data based on the selected data (S4400).

Here, the server (300) for providing a confidential data-based login service matches the created unique identification data and the user ID to each other and stores them (S4500), and if an event of trying the login event occurs in the user terminal (100) (S4600), a check is made on whether the ID data received from the user terminal (100) and the ID data previously stored coincide with each other (S4700).

At this time, if the received ID data and the ID data previously stored coincide with each other, the server (300) for providing a confidential data-based login service mixingly creates the confidential data, similar data and false data (S4800), and if the received ID data and the ID data previously stored do not coincide with each other, the false data is created (S4900).

The server (300) for providing confidential data-based login service transmits the created data to the user terminal (100) (S4910) and receives the unique identification data for the selected data from the user terminal (100) (S4920). Here, the server (300) for providing a confidential data-based login service compares the unique identification data previously stored and the received unique identification data (S4930). If the unique identification data previously stored and the received unique identification data coincide to each other, the login of the user terminal (100) is approved (S4940), and if not, the login of the user terminal (100) fails (S4950).

Particulars not described regarding the method for providing a confidential data-based login service of FIG. 9 as above are identical to those described above regarding the method for providing a confidential data-based login service with reference to FIGS. 1 to 8 or can be easily inferred therefrom, and therefore, related descriptions will be omitted in the following.

The order of the above-described steps (S4100˜S4950) is merely illustrative and the present invention is not limited to it. That is, the order of the above-described steps (S4100˜S4950) may be changed, and some of the steps may be simultaneously carried out or may be omitted.

FIG. 10 is an operational flow chart for describing the method for providing a confidential data-based login service according to the one embodiment of the present invention. Referring to FIG. 10, the server for providing a confidential data-based login service receives the ID data from the user terminal based on the login event (S5100).

Next, the server for providing a confidential data-based login service transmits, to the user terminal, the least one confidential data which has been previously matched to the ID of the user terminal and stored, along with the decoy data and false data (S5200).

Here, the server for providing a confidential data-based login service receives, from the user terminal, the at least one unique identification data corresponding to an event of selecting the at least one confidential data (S5300).

Then, if the at least one received unique identification data and the at least one unique identification data previously matched and stored coincide with each other, the server for providing a confidential data-based login service provides the login service for the user terminal (S5400).

Particulars not described regarding the method for providing a confidential data-based login service of FIG. 10 as above are identical to those described above regarding the method for providing a confidential data-based login service with reference to FIGS. 1 to 9 or can be easily inferred therefrom, and therefore, related descriptions will be omitted in the following.

The method for providing a confidential data-based login service according to the one embodiment described with reference to FIG. 10 may be realized in the form of recording media including a command executable by a computer such as applications or program modules executed by the computer. A computer-readable medium may be any available medium accessible to the computer and includes all of volatile and non-volatile media and separable and non-separable media. Further, the computer-readable medium may include a computer storage medium and a communication medium. The computer storage medium includes all of volatile and non-volatile media and separable and non-separable media realized by any method or technology for storing information such as computer-readable command, data structure, program module or other data. The communication medium typically includes the computer-readable command, data structure, program module or other data of modulated data signal such as carrier wave or other transmitting mechanism and includes any information-transmitting medium.

The method for providing a confidential data-based login service according to the one embodiment of the present invention described above may be implemented by application basically installed in the terminal (the application may include a program included in a platform or operating system or the like basically installed in the terminal), and may be also implemented by application (i.e. program) directly installed in a master terminal by the user through an application-providing server such as application store server, web server associated with application or relevant service or the like. Therefore, the method for providing a confidential data-based login service according to the one embodiment of the present invention described above may be realized by application (i.e. program) basically installed in the terminal or directly installed by the user and may be recorded in the recording medium readable by the computer such as a terminal or the like.

The above description of the present invention is for illustration, and those skilled in the art would appreciate that the above-described embodiment may be easily modified in another particular forms without changing technical concepts or essential features of the present invention. Therefore, it should be understood that embodiments described above are illustrative in all aspects and are not restrictive. For example, each of elements described as being in a single combined form may be discretely implemented, and likewise, each of elements described as being discrete may be implemented in a combined form.

The scope of the present invention is defined by the following claims, rather than the detailed description, and all of altered or modified forms derived from the meaning and scope of the claims and equivalents thereof should be construed to be included within the scope of the present invention.

What is claimed is:

1. A method for providing a confidential data-based login service which is implemented by a sever for providing a confidential data-based login service, comprising:
a step of receiving ID data from a user terminal based on a login event;
a step of transmitting, to the user terminal, at least one confidential data which has been previously matched to the ID of the user terminal and stored, along with decoy data and false data;
a step of receiving, from the user terminal, at least one unique identification data corresponding to an event of selecting the at least one confidential data; and
a step of providing the login service for the user terminal in a case where the at least one received unique identification data and the at least one unique identification data previously matched and stored coincide with each other.

2. The method for providing a confidential data-based login service according to claim 1, wherein the at least one confidential data, which has been previously matched to the ID of the user terminal and stored, is set by implementing a step of receiving the ID data from the user terminal based on an event of request for membership registration; a step of transmitting the at least one confidential data corresponding to the ID data so that the confidential data is displayed on a screen of the user terminal; a step of receiving, from the user terminal, the at least one unique identification data which has been previously matched to the at least one selected confidential data if at least one of the at least one confidential data is selected in the user terminal; and a step of matching the least one received unique identification data to the ID data and storing the same in a labeled table.

3. The method for providing a confidential data-based login service according to claim 1, wherein the at least one confidential data, decoy data and false data transmitted to the user terminal are arranged in array on the screen of the user terminal while mixed with one another, and in a case where a plurality of the confidential data are present, the number of the screens displayed on the user terminal, is determined based on the number of the plurality of confidential data.

4. The method for providing a confidential data-based login service according to claim 1, wherein, when the membership registration event occurs in the user terminal, the at least one unique identification data is randomly created to correspond to the at least one confidential data, and the at least one confidential data and the at least one unique identification data can be matched to each other in an one-to-multi relationship.

5. The method for providing a confidential data-based login service according to claim 1, wherein a probability of the decoy data being exposed in the user terminal is determined based on a probability of the confidential data being exposed.

6. The method for providing a confidential data-based login service according to claim 1, wherein a plurality of the false data are transmitted to the user terminal in a case where the ID data received from the user terminal is not an ID data previously stored and registered.

7. The method for providing a confidential data-based login service according to claim 1, wherein the ID data of the user terminal and the at least one unique identification data are matched to each other and stored in the labeled table in a database, and the at least one confidential data to which the at least one unique identification data has been assigned is stored in a database separate from the database in which the table is stored.

8. The method for providing a confidential data-based login service according to claim 1, wherein the at least one confidential data, decoy data and false data transmitted to the user terminal are displayed such that one data is displayed by stages on the screen of the user terminal.

9. The method for providing a confidential data-based login service according to claim 1, wherein the confidential data is at least one of Passimage, Passvoice, Passvideo and Passmessage.
